(19) United States
(12) Patent Application Publication
(10) Pub. No.: US 2017/0307803 A1
(43) Pub. Date: Oct. 26, 2017

(54) DISPLAY APPARATUS

(71) Applicant: Young Lighting Technology Inc., Hsin-Chu (TW)

(72) Inventors: Hsin-Hung Lee, Hsin-Chu (TW); Yen-Hao Chen, Hsin-Chu (TW); Chao-Chun Cheng, Hsin-Chu (TW); Chiao-Chih Yang, Hsin-Chu (TW); Huei-Tzu Lin, Hsin-Chu (TW)

(73) Assignee: Young Lighting Technology Inc., Hsin-Chu (TW)

(21) Appl. No.: 15/448,603

(22) Filed: Mar. 3, 2017

(30) Foreign Application Priority Data
Apr. 25, 2016 (TW) 105205818

(51) Int. Cl. F21V 8/00

(52) U.S. Cl. CPC G02B 6/0046; G02B 6/0068; G02B 6/0061; G02B 6/0031; G02B 6/0051; G02B 6/0056

(57) ABSTRACT

A display apparatus including an image unit, a light source module and a transparent plate is provided. The image unit has an image display surface which includes a first side and a second side opposite to the first side. The light source module is disposed at the first side of the image display surface, and adapted to serve as a front light source of the image unit to provide a light beam to the image display surface. The transparent plate is disposed above the image display surface.

### CROSS-REFERENCE TO RELATED APPLICATION

This application claims the priority benefit of Taiwan application serial no. 105205818, filed on Apr. 25, 2016. The entirety of the above-mentioned patent application is hereby incorporated by reference herein and made a part of this specification.

### BACKGROUND OF THE INVENTION

### Field of the Invention

The invention relates to a display apparatus, and particularly relates to a display apparatus including a front light source structure.

### Description of Related Art

The conventional front light source techniques are normally applied in advertisement billboards for promoting products or commercial activities. The conventional billboards are used with light guide plates and projects light from lateral or vertical sides, so as to illuminate posters or printed products. However, the projection light sources for such billboards are large in size and separated from the posters or printed products, making such light sources less convenient to install.

In the meantime, the display apparatuses have been gradually developed to become lighter and thinner as the modern technologies advance. With the so-called e-papers (or also referred to as electrophoresis displays) brought to the market, e-papers gradually replace the conventional advertisement billboards. The e-papers are electrically connected to switch components to drive electronic ink. However, in the conventional e-papers, the light guide plates need to be attached to display surfaces to enable reading in low luminance. However, since such display apparatuses include light guide plates, the manufacturing cost thereof is higher. In addition, when the light guide plates are attached to the display surfaces, some defect may occur, which makes the yield rate thereof not desirable. In addition, since the light utilization rate of such display apparatuses is lower, it is difficult to use such display apparatuses as large-sized advertisement billboards.

The information disclosed in the “BACKGROUND OF THE INVENTION” section is only for enhancement of understanding of the background of the described technology, and therefore it may contain information that does not form the prior art that is already known to a person of ordinary skill in the art. Further, the information disclosed in the “BACKGROUND OF THE INVENTION” section does not mean that one or more problems to be resolved by one or more embodiments of the invention was acknowledged by a person of ordinary skill in the art.

### SUMMARY OF THE INVENTION

The invention provides a display apparatus that is thinner and has a lower manufacturing cost. In addition, the display apparatus has a preferable light utilization rate.

Other objects and advantages of the invention can be further illustrated by the technical features broadly embodied and described as follows.

In order to achieve one or a portion of or all of the objects or other objects, an embodiment of the invention provides a display apparatus. The display apparatus includes an image unit, a first light source module, and a transparent plate. The image unit has an image display surface. The image display surface includes a first side and a second side opposite to the first side. The first light source module is disposed at the first side of the image display surface and configured to serve as a front light source of the image unit to provide a beam to the image display surface. The transparent plate is disposed above the image display surface.

Based on the above, the embodiments of the invention at least exhibit one of the following characteristics or effects. The light source module according to the embodiments of the invention is disposed at at least one side of the image display surface and serves as a front light source of the image unit, so as to facilitate the light utilization rate of the display apparatus.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1A is a schematic view illustrating a display apparatus according to a first embodiment of the invention.

FIG. 1B is a cross-sectional view illustrating the display apparatus according to the first embodiment of the invention along an A-A cross-section.

FIG. 1C is a cross-sectional view illustrating the display apparatus including an upper polarizer according to the first embodiment of the invention along the A-A cross-section.

FIG. 2A is a schematic view illustrating a display apparatus according to a second embodiment of the invention.

FIG. 2B is a cross-sectional view illustrating the display apparatus according to the second embodiment of the invention along the A-A cross-section.

FIG. 3A is a schematic view illustrating a display apparatus according to a third embodiment of the invention.

FIG. 3B is a cross-sectional view illustrating the display apparatus according to the third embodiment of the invention along the A-A cross-section.

FIG. 3C is a cross-sectional view illustrating the display apparatus without a diffuser according to the third embodiment of the invention along the A-A cross-section.

FIGS. 4A, 4B, and 4C are schematic views illustrating diffusers of the display apparatus according to the third embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

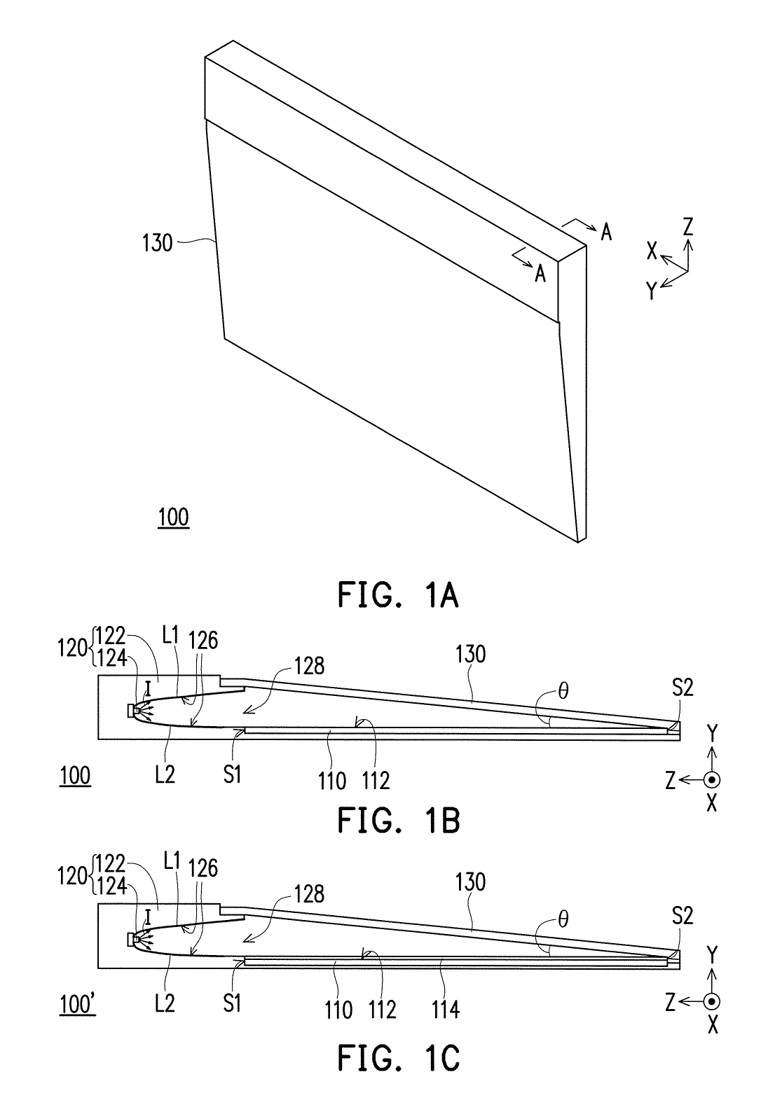

FIG. 1 is a schematic view illustrating a display apparatus according to a first embodiment of the invention. FIG. 1B is a cross-sectional view illustrating the display apparatus according to the first embodiment of the invention along an A-A cross-section. Referring to FIGS. 1A and 1B, a display apparatus 100 of this embodiment includes an image unit 110, a first light source module 120, and a transparent plate 130. The image unit 110 has an image display surface 112. The image display surface 112 includes a first side S1 and a second side S2 opposite to the first side S1. For example, in FIG. 1A, the first side S1 and the second side S2 of the image display surface 112 may refer to an upper side and a lower side of the image display surface 112, for example, based on a configuration of the display apparatus 100. The first light source module 120 is disposed at the first side S1 of the image display surface 112, and configured as a front light source of the image unit 110, so as to provide a beam I to the image display surface 112. The transparent plate 130 is disposed above the image display surface 112. The display apparatus 100 has a front view direction Y. The image unit 110 is configured to reflect the beam I to display an image frame in the front view direction Y.

In this embodiment, the display apparatus 100 may be used in an advertisement billboard, an advertisement window, a decoration window, or a transparent window for a conference room, etc., for example. Thus, the image unit 110 may be a printed advertisement, a painting, a reflective liquid crystal display, or a reflective electro-wetting display, etc. It shall be noted that the invention does not intend to impose a limitation on the use of the display apparatus.

Secondly, in this embodiment, the first light source module 120 may be configured to reflect the beam I through total internal reflection. Moreover, in this embodiment, the transparent plate 130 may include polymethylmethacrylate (PMMA) or polycarbonate (PC). However, the invention does not intend to impose a limitation on the material of the transparent plate 130.

In this embodiment, the transparent plate 130 is disposed above the image display surface 112 and inclined respect to the image display surface 112. In addition, an included angle θ is formed between the transparent plate 130 and the image display surface 112, and the included angle θ is smaller than 15 degrees, such that the light beam I is emitted to the transparent plate 130 at a large angle. For example, in an exemplary embodiment where the included angle θ is smaller than 15 degrees, an incident angle of the beam I to the transparent plate 130 may be controlled to be 80 degrees or more. Thus, the transparent plate 130 may reflect 65% or more of light to the image display surface 112 of the image unit 110. In addition, the transparent plate 130 extends from the second side S2 toward the first side S1 at a predetermined slope. When a thickness of the transparent plate 130 is from 0.5 millimeters to 2 millimeters, a view ability is more preferable. If the transparent plate 130 is too thick, a double image of the ambient light may occur, and a manufacturing cost of the transparent plate 130 may also increase. In addition, a refractive index of the transparent plate 130 is greater than 1.4, and when the refractive index of the transparent plate 130 is higher, an effect of reflection becomes better.

In this embodiment, the first light source module 120 includes a reflective cover 122 and a light emitting device 124. The first light source module 120 is disposed at the first side S1. The reflective cover 122 is connected to the image unit 110. The light emitting device 124 is disposed in the reflective cover 122 and configured to provide the beam I. The reflective cover 122 adjusts a light shape of the beam I to make the beam I a collimated beam. Namely, the beam I is substantially parallel to the image display surface 112. One end of the transparent plate 130 is located at the second side S2 of the image display surface 112 and mounted by the image unit 110 or the image display surface 112. The other end of the transparent plate 130 is located on the first light source module 120 and mounted by the first light source module 120 or the reflective cover 122. The transparent plate 130 extends from the second side S2 toward the first side S1 at a predetermined slope. Here, the transparent plate 130 is disposed above the image display surface 112 and inclined in a manner that the end of the transparent plate 130 at the first side S1 is higher and the end of the transparent plate 130 at the second side S2 is lower. Furthermore, in other embodiments, the first light source module 120 may also be disposed at the second side S2, and the transparent plate 130 may extend from the first side S1 toward the second side S2 at the same or different predetermined slopes (not shown). However, it should be noted that the invention does not intend to impose a limitation in this regard.

In this embodiment, the reflective cover 122 includes a reflective surface 126 and a light emitting opening 128. The reflective surface 126 is a hyperbolic surface. The light emitting device 124 is disposed in the reflective cover 122. The reflective surface 126 is located at least two sides of the light emitting device 124. A horizontal height of the light emitting device 124 in the Y direction is higher than a horizontal height of the image display surface 112. The light emitting device 124 may include a light emitting diode (LED) or a cold cathode fluorescent lamp (CCFL), for example. However, it shall be noted that the invention does not intend to impose a limitation on the forms and types of the source of light emission. The light emitting opening 128 is located at a side of the reflective cover 122 adjacent to the image display surface 112. Namely, the light emitting opening 128 is an opening located at a side of the reflective cover 122 toward the image display surface 112, such that the reflective cover 122 exhibits a design of cavity. The reflective cover 122 adjusts the light shape of the beam I to make the beam I a collimated beam output from the light emitting opening 128 to the transparent plate 130.

More specifically, in this embodiment, the hyperbolic surface symmetrically extends from the first side S1 toward the second side S2 using the light emitting device 124 as a reference. The hyperbolic surface includes a first curved surface and a second curved surface (not shown). Referring to FIG. 1B, based on the cross-section A-A of the display apparatus 100, the first curved surface and the second curved surface correspond to a first curve L1 and a second curve L2. Absolute values of tangent slopes of the first curve L1 and the second curve L2 gradually decrease from the first side S1 toward the second side S2. In addition, the cross-section A-A is perpendicular to the image display surface 112.

In an embodiment, the reflective surface 126 may use the light emitting device 124 as the reference, for example, and asymmetrically extend from the second side S2 toward the first side S1. Namely, changes of the absolute values of the tangent slopes of the first curve L1 and the second curve L2 may be inconsistent. In an embodiment, the absolute values of the tangent slopes of the first curve L1 and the second curve L2 may gradually increase from the first side S1 toward the second side S2. The invention does not intend to impose a limitation on the design of the first curve L1 and the second curve L2.

Specifically, in this embodiment, the reflective cover 122 may be a collimating cover, and the reflective surface 126 may adjust the beam I provided by the first light source module 120 so that the beam I is transmitted toward the image unit 110 along a Z direction. In addition, a portion of the beam I collimated and output may be projected onto the transparent plate 130 and then reflected to the image unit 110 through the transparent plate 130, so as to increase a light utilization rate.

Specifically, in this embodiment, a process of manufacturing the reflective cover 122 may include adopting an injection plastic component, producing a reflective surface curvature, and forming a reflective material, such as metal or coating layer, on an inner surface of the reflective cover 122, or forming a reflective surface 126 by adhering a reflective material, or forming the reflective cover 122 by integral formation, such that the reflective surface 126 may reflect the light illuminated onto the inner surface of the reflective cover 122.

FIG. 1C is a cross-sectional view illustrating the display apparatus including an upper polarizer according to the first embodiment of the invention along the A-A cross-section. Referring to FIG. 1C, in this embodiment, a display apparatus 100′ includes an upper polarizer 114, for example. In addition, the upper polarizer 114 has a first polarization direction. In an exemplary embodiment of a reflective liquid crystal display, the upper polarizer 114 is disposed on the image display surface 112 of the image unit 110, for example. If the first polarization direction of the upper polarizer 114 is an S polarization direction, a utilization efficiency of a polarized beam in the S polarization direction reflected by the transparent plate 130 may be improved. Sufficient teaching, suggestions, and descriptions for embodiment about the structure and specific details of operations concerning the display apparatus 100′ of this embodiment may be obtained from the descriptions of the embodiment shown in FIG. 1B. Therefore, details in these respects will not be described in the following.

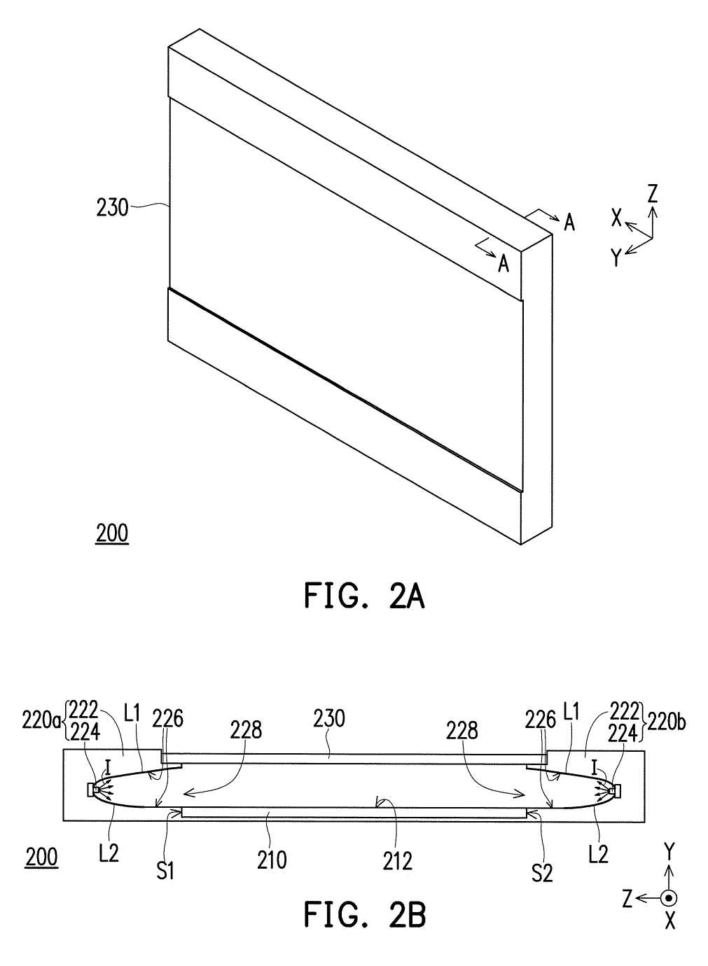

FIG. 2A is a schematic view illustrating a display apparatus according to a second embodiment of the invention. FIG. 2B is a cross-sectional view illustrating the display apparatus according to the second embodiment of the invention along the A-A cross-section. Referring to FIGS. 2A and 2B, a display apparatus 200 of this embodiment is similar to the display apparatus 100 of FIG. 1B, except for a main difference that, for example, the display apparatus 200 further includes a second light source module 220b, and a transparent plate 230 is disposed in parallel to an image display surface 212. In this embodiment, a first light source module 220a and the second light source module 220b are respectively disposed beside the first side S1 and the second side S2. The transparent plate 230 is located above an image unit 210, the first light source module 220a, and the second light source module 220b. The display apparatus 200 has the front view direction Y. The image unit 210 is configured to reflect the beam I to display an image frame in the front view direction Y. In other embodiments, the transparent plate 230 may not be disposed in parallel to the image display surface 212. Namely, there is an included angle θ between the transparent plate 230 and the first side S1 or the second side S2 of the image display surface 212, and the included angle θ is smaller than 90 degrees (not shown).

In this embodiment, when viewed from the cross-section A-A of the display device 200, the image unit 210 is used as a reference and the first light source module 220a and the second light source module 220b are disposed opposite to each other. Moreover, in an embodiment, the image unit 210 may also include an upper polarizer in the first polarization direction and disposed on the image display surface 212. The structure and specific details of the operation of the upper polarizer are similar to those in FIG. 1C and thus not repeated in the following.

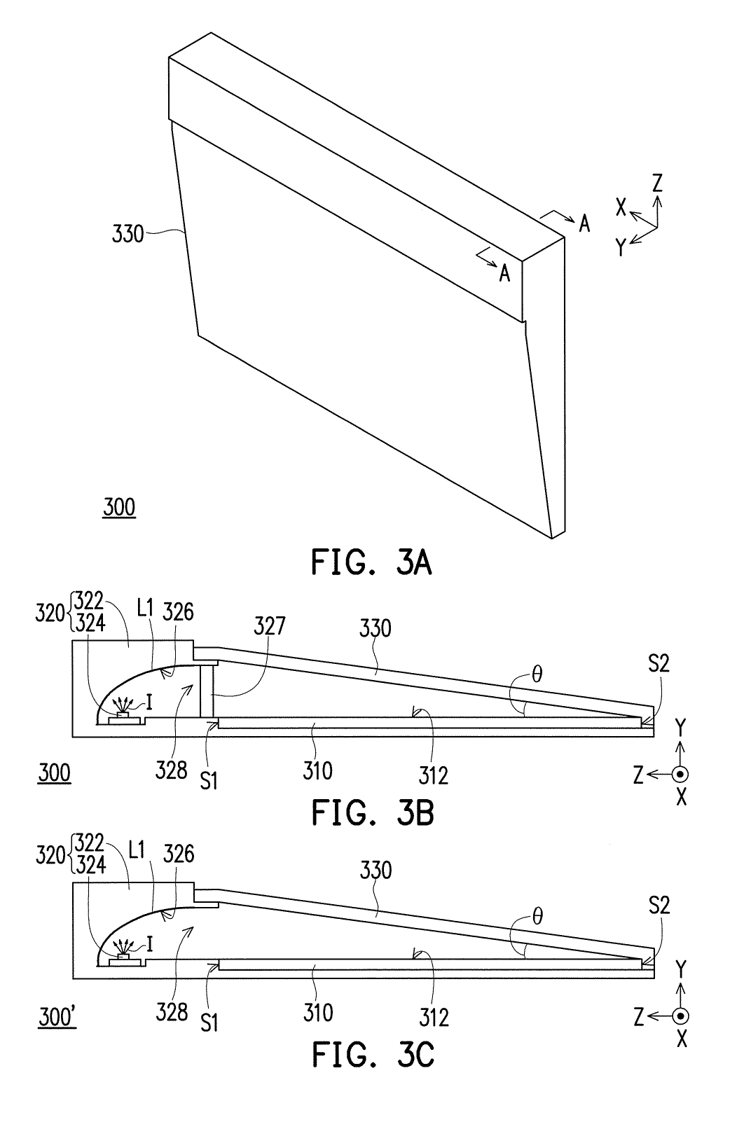

FIG. 3A is a schematic view illustrating a display apparatus according to a third embodiment of the invention. FIG. 3B is a cross-sectional view illustrating the display apparatus according to the third embodiment of the invention along the A-A cross-section. Referring to FIGS. 3A and 3B, a display apparatus 300 of this embodiment is similar to the display apparatus 100 of FIG. 1B, except for a main difference in, for example, a designed structure of a first light source module 320. Specifically, the display apparatus 300 has the front view direction Y. An image unit 310 is configured to reflect the beam I to display an image frame in the front view direction Y. An image display surface 312 includes the first side S1 and the second side S2. The first light source module 320 includes a reflective cover 322 and a light emitting device 324. The first light source module 320 may be disposed at the first side S1 or the second side S2. However, the invention does not intend to impose a limitation on the position where the first light source module 320 is disposed. The embodiment is described herein by assuming that the first light source module 320 is disposed at the first side S1.

In addition, sufficient teaching, suggestions, and descriptions for embodiment about the arrangement of other components of this embodiment may be obtained from the descriptions of the first and second embodiments. Thus, details in these respects will not be described in the following. In this embodiment, a reflective surface 326 is a single curved surface, and a horizontal height of the light emitting device 324 is lower than a horizontal height of the image display surface 312 in the Y direction. In an embodiment, a position of the light emitting device 324 and the image display surface 312 may also be substantially on the same horizontal plane. Moreover, in this embodiment, the first light source module 320 further includes a diffuser 327 disposed at a light emitting opening 328 of the reflective cover 322.

Referring to FIG. 3B, in this embodiment, the reflective surface 326 extends from the first side S1 toward the second side S2 based on the light emitting device 324. The reflective surface 326 is a curved surface. When viewed from the cross-section A-A of the display apparatus 300, the curved surface corresponds to the curve L1. The tangent slope of the curve L1 gradually decreases from the first side S1 toward the second side S2. The cross-section A-A is perpendicular to the image display surface 312. Besides, in an embodiment, the tangent slope of the curve L1 gradually increases from the first side S1 toward the second side S2. However, the invention does not intend to impose a limitation in this regard.

In this embodiment, the display apparatus 300 shown in FIG. 3B is merely described for an illustrative purpose. FIG. 3C is a cross-sectional view illustrating the display apparatus without a diffuser according to the third embodiment of the invention along the A-A cross-section. Referring to FIG. 3C, in a display apparatus 300′, the diffuser 327 may not be disposed at the light emitting opening 328 of the reflective cover 322. Alternatively, in an embodiment, the image unit 310 may further include an upper polarizer (not shown) having the first polarization direction and disposed on the image display surface 312. The structure and specific details of the operation of the upper polarizer are similar to the arrangement shown FIG. 1C and thus not repeated in the following.

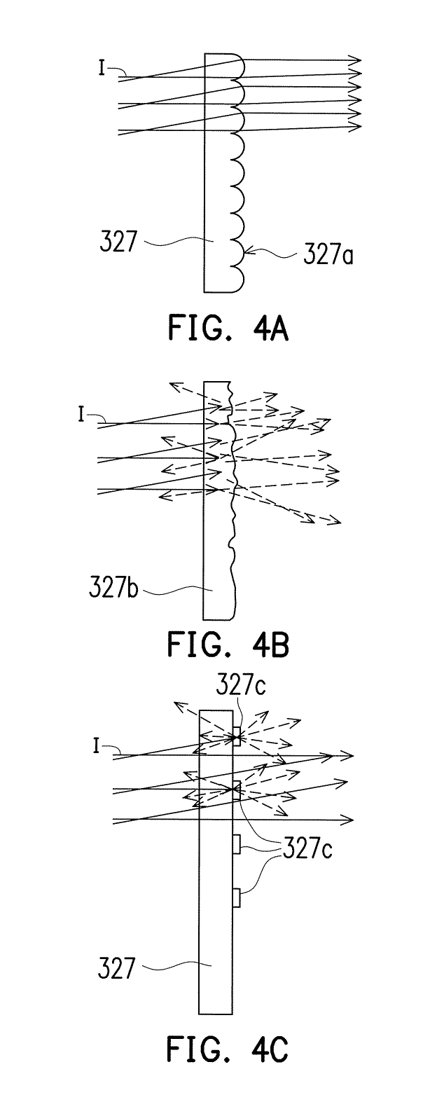

FIGS. 4A, 4B, and 4C are schematic views illustrating diffusers of the display apparatus according to the third embodiment of the invention. Referring to FIG. 4A, in this embodiment, the diffuser 327 is an optical functional plate having a surface with a plurality of outwardly protruding structure dots 327a. A shape of a projection of the outwardly protruding structure dot 327a on the surface may be circular or rectangular. The outwardly protruding structure dots 327a are transparent and colorless, and a material of the outwardly protruding structure dots 327a may be selected from resin, glass, or other equivalent or similar materials. Even though the outwardly protruding structure dots 327a are described as being disposed on a surface of the diffuser 327, the invention is not limited thereto. In other embodiments, the outwardly protruding structure dots 327a may also be disposed on another surface or a plurality of surfaces of the diffuser 327.

Alternatively, referring to FIG. 4B, the diffuser 327 in this embodiment may also be a diffusing plate 327b having micro-particles. Thus, when passing through the diffuser 327, light may repetitively pass through media having different refractive indices, and light may consequently be refracted, reflected, and scattered at the same time, so as to offer an effect of optical diffusion.

Referring to FIG. 4C, in this embodiment, the diffuser 327 may also be a printed transparent plate. Patterned diffusion dots 327c are printed on a surface of the printed transparent plate, and an interval is provided between the diffusion dots 327c, such that the beam I is not interfered when passing through, whereas reflected light are diffused at various angles. By using the diffusion dots 327c in different densities and sizes, the total reflection of light is destroyed. The greater an refractive index, the better a light guide capability of the diffuser 327 becomes. Even though the diffusion dots 327c are described as being disposed on a surface of the diffuser 327, the invention is not limited thereto. In other embodiments, the diffusion dots 327a may also be disposed on another surface or a plurality of surfaces of the diffuser 327.

In brief, the diffuser 327 mainly serves to provide a surface light source with a uniform brightness distribution by means of diffusion of light through an optical material, so as to enhance the brightness. Thus, the diffuser 327 may be disposed in any one of the embodiments of the invention to enhance the light emitting uniformity and brightness of the display apparatus. A material of the diffuser 327 may include a material having a light transmittance rate, such as polyethylene terephthalate (PET or PETE), PC, or PMMA, etc. However, it should be understood that the invention does not intend to impose a limitation in this regard.

In view of the foregoing, the embodiments of the invention at least exhibit one of the following characteristics or effects. The display apparatus according to the embodiments of the invention adjusts the light shape of the light source to make the light a collimated light beam by using the reflective cover, such that the collimated light beam is substantially parallel to the image display surface of the image unit, and the light beam is emitted to the transparent plate at a large angle. The optical properties of the transparent plate itself result in a high reflectivity. Therefore, the beam is directed to the image unit and the image frame is reflected for the viewer's perception. In other words, by using the optical properties of the transparent plate and the arrangement of the light source module, the embodiments of the invention are able to effectively increase the light utilization rate, making display apparatus able to be applied in a large-sized billboard. In addition, since the components of the display apparatus according to the embodiments of the invention are fewer, the display apparatus may be thinner and the manufacturing cost thereof may be lower. In addition, with a simpler structure, the display apparatus according to the embodiments of the invention is easier to install, so the time required to install an advertisement billboard may also be reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A display apparatus, comprising:
an image unit, having an image display surface comprising a first side and a second side opposite to the first side;
a first light source module, disposed at the first side of the image display surface and configured to serve as a front light source of the image unit to provide a beam to the image display surface; and
a transparent plate, disposed above the image display surface.

2. The display apparatus as claimed in claim 1, wherein the transparent plate is disposed above the image display surface and inclined with respect to the image display surface, an included angle is provided between the transparent plate and the image display surface, and the transparent plate extends from the second side toward the first side at a predetermined slope.

3. The display apparatus as claimed in claim 2, wherein the included angle is smaller than 15 degrees.

4. The display apparatus as claimed in claim 2, wherein a thickness of the transparent plate is in a range from 0.5 millimeters to 2 millimeters.

5. The display apparatus as claimed in claim 2, wherein a refractive index of the transparent plate is greater than 1.4.

6. The display apparatus as claimed in claim 1, wherein the first light source module comprises:
a reflective cover, disposed at the first side, wherein the reflective cover comprises a reflective surface and a light emitting opening; and
a light emitting device, disposed in the reflective cover,
wherein the reflective surface covers the light emitting device, and the light emitting opening is located at a side of the reflective cover adjacent to the image display surface.

7. The display apparatus as claimed in claim 6, wherein the reflective surface is a hyperbolic surface, and the hyperbolic surface symmetrically extends from the first side toward the second side using the light emitting device as a reference.

8. The display apparatus as claimed in claim 7, wherein a horizontal height at a location of the light emitting device is higher than a horizontal height of the image display surface.

9. The display apparatus as claimed in claim 7, wherein the hyperbolic surface includes a first curved surface and a second curved surface, the first curved surface and the second curved surface correspond to a first curve and a second curve when viewed from a cross-section of the display apparatus, absolute values of tangent slopes of the first curve and the second curve gradually decrease from the first side toward the second side, and the cross-section is perpendicular to the image display surface.

10. The display apparatus as claimed in claim 6, wherein the reflective surface is a curved surface, and the curved surface extends from the first side toward the second side using the light emitting device as a reference.

11. The display apparatus as claimed in claim 10, wherein a horizontal height at a location of the light emitting device is lower than a horizontal height of the image display surface, or the light emitting device and the image display surface are located on the same horizontal plane.

12. The display apparatus as claimed in claim 10, wherein the curved surface corresponds to a curve when viewed from a cross-section of the display apparatus, a tangent slope of the curve gradually decreases from the first side toward the second side, and the cross-section is perpendicular to the image display surface.

13. The display apparatus as claimed in claim 6, wherein the first light source module further comprises a diffuser disposed at the light emitting opening of the reflective cover.

14. The display apparatus as claimed in claim 1, wherein the image unit comprises an upper polarizer having a first polarization direction and disposed on the image display surface.

15. The display apparatus as claimed in claim 1, further comprising a second light source module disposed beside the second side of the image display surface, wherein the transparent plate is located above the image unit, the first light source module, and the second light source module, and the transparent plate is disposed in parallel to the image display surface.
